(19) United States
(12) Patent Application Publication
(10) Pub. No.: US 2026/0360782 A1
(43) Pub. Date: Nov. 12, 2026

(54) METHOD FOR CARRYING OUT A REWETTING MEASURE OF A FUEL CELL STACK

(71) Applicant: Robert Bosch GmbH, Stuttgart (DE)

(72) Inventors: Michael Giuseppe Marino, Linz (AT); Christophe Gerling, Filderstadt (DE); Jochen Wessner, Esslingen (DE); Juergen Hackenberg, Sachsenheim (DE); Ulrich Sauter, Karlsruhe (DE); Ulrich Berner, Stuttgart (DE)

(21) Appl. No.: 19/140,424

(22) PCT Filed: Dec. 15, 2023
(86) PCT No.: PCT/EP2023/086079

§ 371 Date: Jun. 18, 2025

(30) Foreign Application Priority Data
Dec. 19, 2022 (DE) 10 2022 213 887.2

(51) Int. Cl. H01M 8/04828; H01M 8/04228; H01M 8/04303; H01M 8/04492; H01M 8/04746; H01M 8/04858

(52) U.S. Cl. CPC H01M 8/04828; H01M 8/04228; H01M 8/04303; H01M 8/04492; H01M 8/04753; H01M 8/0491; H01M 2250/20

(57) ABSTRACT

The invention relates to a method (200) for carrying out a rewetting measure of a fuel cell stack (10) of a fuel cell assembly (1), preferably a fuel cell vehicle, wherein, during operation of the fuel cell assembly (1), a moisture quality of the fuel cell stack (10) is determined, which represents a degree of dryness of at least one region of the fuel cell stack (10). Based on this moisture quality, a decision is made regarding the extent to which the rewetting measure of the at least one too-dry region of the fuel cell stack (10) is or and/or should be carried out. The rewetting measure is carried out by actively influencing an electric current that is and/or can be generated by the fuel cell stack (10).

### BACKGROUND

The invention relates to a method for carrying out a rewetting measure of a fuel cell stack in a fuel cell assembly, preferably in a fuel cell vehicle. Furthermore, the invention relates to a fuel cell assembly, a fuel cell system, or a fuel cell vehicle.

In a low-temperature polymer electrolyte fuel cell of a fuel cell unit (stationary or mobile), e.g., of a fuel cell system of a fuel cell vehicle, an electrochemical conversion of two reactants of two operating media into electrical energy and heat takes place. The fuel cell in this case comprises at least one membrane electrode assembly (MEA). As a rule, the fuel cell is designed to comprise a plurality of membrane electrode assemblies arranged in a stack and bipolar plates arranged between them (fuel cell stack or stack having a plurality of individual fuel cells).

### SUMMARY

Fuel cell stacks should be operated moistly up to as moistly as possible in order to reduce their ohmic resistance, but not so wet as to cause partial flooding. Due to some operating conditions of a fuel cell stack, such as excessive temperature, overload, environmental conditions, elapsed time, and/or a long idling phase of a fuel cell assembly, the fuel cell stack can become too dry, reducing its efficiency. Excessively dry fuel cell stacks can lead to irreversible degradation of their membrane-electrode units. A problem addressed by the invention is to provide a method for rewetting a fuel cell stack.

The problem addressed by the invention is solved by a method for carrying out a rewetting measure of a fuel cell stack of a fuel cell assembly, preferably of a fuel cell vehicle, as well as by means of a fuel cell assembly, a fuel cell system, or a fuel cell vehicle. Advantageous further developments, additional features and/or advantages of the invention are apparent from the disclosure and the following description.

In the method according to the invention, preferably during operation of the fuel cell assembly, a moisture quality of the fuel cell stack is determined, which represents a degree of dryness of at least one region of the fuel cell stack, and based on this moisture quality, a decision is made regarding the extent to which the rewetting measure of the at least one too-dry region of the fuel cell stack is or and/or should be carried out, wherein the rewetting measure is preferably carried out by actively influencing an electric current that is and/or can be generated by the fuel cell stack.

The moisture quality allows for simple and reliable detection and execution of the need for rewetting of the fuel cell stack. This results in higher efficiency (performance, service life, etc.) of the fuel cell stack, lower hydrogen consumption, reduced heat generation, etc. Furthermore, dry or excessively dry operating conditions of the fuel cell stack can be counteracted.

During the rewetting measure, the current that is and/or can be generated by the fuel cell stack is or can be significantly reduced, the current is or can be intermittently produced, and/or the current has a global minimum compared to a duration immediately before and/or immediately after the rewetting measure.

Under substantially comparable specified operating conditions, an average electrical charge generated by the fuel cell stack during a/the duration of the rewetting measure in a unit of time can be less than an average electrical charge generated by the fuel cell stack in the same unit of time during a comparison period before, after, or while determining the rewetting measure via the moisture quality.

The average charge generated per unit of time during the rewetting measure can be approximately 75%, 70%, 65%, 60%, 57.5%, 55%, 52.5%, 50%, 49%, 48%, 47%, 46%, 45% or less of the charge generated by the fuel cell stack for the same unit of time during the comparison period. The respective unit of time can be approximately 0.1 s, 0.2 s, 0.25 s, 0.5 s, 1.0 s, 2 s, 3 s, 4 s, 5 s, 6 s, 7 s, 8 s, 9 s, 10 s, or more.

The current that is and/or can be generated by the fuel cell stack during a rewetting measure can be separated into at least a current-on phase and a reduced current-on phase, in which the current that is and/or can be generated is lower than in the current-on phase.

Furthermore, the current that is and/or can be generated by the fuel cell stack during a rewetting measure can be separated into at least a current-on phase and a current-off phase, in which the current that is and/or can be generated is switched off compared to the current-on phase.

The method conveys water into an ionomer of the fuel cell stack during a current-on phase. In an immediately subsequent reduced current-on phase or current-off phase, the ionomer has time to adjust/relax to the newly added water, which takes some time. In this way, wetting of the fuel cell stack with such current phases can be more effective than with a continuous high current.

During a reduced current-on phase or a current-off phase, missing current can be drawn from a battery and/or the fuel cell assembly can be operated at reduced power during the rewetting measure. In this case, the current generated intermittently by the fuel cell stack can be temporarily buffered in a battery and removed from it substantially continuously.

A current-on phase can last approximately 15 s, 30 s, 40 s, 50 s, 60 s, 70 s, 80 s, 90 s, 105 s, 120 s, 130 s, 140 s, 150 s, 180 s, or longer. A reduced current-on phase or a current-off phase can last approximately: 15 s, 30 s, 40 s, 50 s, 60 s, 70 s, 80 s, 90 s, 105 s, 120 s, 130 s, 140 s, 150 s, 180 s, or longer. The number of reduced current-on phases or current-off phases can be approximately five, seven, ten, 15, 20, 25, 30, or more. The current-on phases behave analogously.

The fuel cell stack can provide approximately 70%, 75%, 80%, 85%, 90%, 92.5%, 95%, 97.5%, 98%, 99% or 100% of its prevailing maximum output in at least one, a plurality, a majority, or substantially all of its current-on phases. Furthermore, the fuel cell stack can provide approximately 0%, 5%, 10%, 15%, 20%, 25%, 30%, 35%, 40%, 45%, 50%, 55% or 60% of its prevailing maximum output in at least one reduced current-on phase. Additionally, the fuel cell stack can provide approximately 0%, 0.5%, 1%, 2%, 3%, 4% or 5% of its prevailing maximum output in a current-off phase.

For example, if one completely shuts off an air volume flow in the cathode supply, one has 0% in a reduced current-on phase, i.e., no current at all (this can also be considered a current-off phase). For air volume flows greater than zero, other power points/ranges can then occur in the reduced current-on phases. Here, it is possible to vary the power point/range by controlling voltage through electronics.

A ramp-down (reduced current-on phase(s)) or a shutdown (current-off phase(s)) of the fuel cell stack can occur during an activated current flow of the fuel cell stack. In particular, an air volume flow into the cathode of the fuel cell stack can be switched off. This prevents further drying of the cathode, and harmful high potentials can be avoided (oxygen depletion).

The moisture quality can be determined from an electric high-frequency resistance of at least a portion of the fuel cell stack; by monitoring at least one operating parameter, in particular a cell voltage, of the fuel cell stack or the fuel cell assembly; and/or by comparing at least one cell voltage of the fuel cell stack to a stored cell voltage.

In principle, the current ((reduced) current-on phase), the high-frequency resistance, the cell voltage and/or the operating parameter(s) can be measured (preferably), detected, sensed, diagnosed (AI: Artificial Intelligence) and/or determined by a model (physically, AI, or hybrid). The term cell voltage is intended to encompass not only a cell voltage of a single cell, but also the electrical (cell) voltage of a plurality, majority, or all individual cells of the fuel cell stack. The portion of the fuel cell stack can comprise a single, plurality, majority, or all of the individual cells of the fuel cell stack. The same is true analogously for the cell voltage and/or the at least one (other) operating parameter of the fuel cell assembly or the fuel cell stack.

For the determination, the high-frequency resistance, cell voltage, and/or operating parameter can be included in the moisture quality as a singular, periodic, discontinuous or continuous value, as a derivative, and/or as an integral. If the high-frequency resistance, the cell voltage and/or the operating parameter are included as a derivative, this can be a first-order and/or a higher-order derivative. This can be transferred to an integral as well.

The operating parameter can be one of a fuel cell system, a fuel cell assembly, a fuel cell stack, an anode supply, a cathode supply, a moisture exchanger, and/or a coolant supply. An operating parameter can be, for example, an electrical voltage, an electric current (outside of the (reduced) current-on phase(s), current-off phase(s)), an electric current density, a ratio of voltage to current, etc. of the fuel cell stack, in particular of at least a portion of the fuel cell stack. Furthermore, an operating parameter can be a gas pressure, a gas volume flow, a gas moisture, a stoichiometry, a media flow, a mass flow and/or a temperature, etc. on the anode side and/or on the cathode side of the fuel cell stack.

Moreover, it is possible to apply an operating parameter outside of the anode and/or the cathode, e.g., one of an anode supply, a cathode supply, the moisture exchanger, the coolant supply (coolant temperature), etc. of the fuel cell assembly. Furthermore, a value of the high-frequency resistance, the cell voltage, and/or the operating parameter can be determined based on triggering by a system variable (e.g., its value). For example, a load requirement on the fuel cell assembly, a power output of the fuel cell assembly, etc., can be used.

In a simple case, the determined moisture quality of the fuel cell stack can be determined from at least a single value of the high-frequency resistance, the cell voltage and/or the operating parameter. However, preferably a discontinuous or continuous value curve of the high-frequency resistance, the cell voltage and/or the operating parameter is used for this purpose.

When determining the moisture quality, a difference calculation of two values of the high-frequency resistance, the cell voltage and/or the operating parameter can be applied. Thus, the arbitrary or necessary rewetting measure can be determined when exceeding or falling below a difference limit of at least two or a plurality/majority of successive measurements. Of course, trends can also be examined and applied.

To determine the high-frequency resistance, a high-frequency signal can be superimposed on a DC signal of the fuel cell stack (impedance spectroscopy), wherein the determined high-frequency resistance is preferably evaluated by a generating source and/or by another device. The superimposed voltage amplitudes are preferably less than 100 mV, 75 mV, 50 mV, 40 mV, 30 mV, 25 mV, 20 mV, 15 mV, 10 mV, 7.5 mV, 5 mV, 2.5 mV, 2 mV, 1.5 mV, 1 mV or 0.5 mV. The superimposition of the high-frequency signal can be done, for example, by means of an inverter and/or a DC/DC converter that modulates a high-frequency signal.

The frequencies of the high-frequency signal are preferably in a frequency range greater than 1 kHz; in particular, frequencies greater than 1.5 kHz, 2 kHz, 2.5 kHz, 5 kHz, 7.5 kHz, 10 kHz, 15 kHz, 20 kHz, 25 kHz, 30 kHz, 40 kHz, 50 kHz, or above can be applied. The inverter and/or the DC/DC converter (DC: Direct Current) can have a pulse-width modulation unit in order to superimpose the high-frequency signal onto a DC supply. For this purpose, existing DC supply lines can be used by an inverter and/or a DC/DC converter.

To increase reliability and/or accuracy, for example of a measurement, the frequency of pulse-width modulation can be adjusted to match the operating state of the fuel cell stack. A frequency can be chosen that is at least twice as high as the frequency of interference on a current signal (Shannon sampling theorem).

In the moisture quality, a rewetting measure can be represented by an increase in high-frequency resistance and a decreasing cell voltage during operation of the fuel cell assembly. Preferably, a too-dry region of the fuel cell stack can be represented in the moisture quality by falling below a threshold of a cell voltage and/or exceeding a threshold of a high-frequency resistance under given operating conditions of the fuel cell assembly.

At least the high-frequency resistance and the cell voltage form the moisture quality. For example, the rewetting measure can be initiated if a moisture quality falls below a certain level. The cell voltage can be obtained from a cell monitoring (CVM) system (CVM: cell voltage monitoring).

If the fuel cell stack reaches a state that is at least sufficiently moist or substantially at target moisture, or if the operating condition of the fuel cell stack has stabilized, the fuel cell assembly can be switched back to normal operating conditions in order to avoid partial flooding of the fuel cell stack. Due to the high-frequency measurement, a desired water content in the fuel cell stack can be continuously monitored and thus controlled to at least good or substantially optimal operating parameters.

Upon detection of a too-dry region of the fuel cell stack based on the moisture quality, the rewetting measure for the fuel cell stack is and/or can be initiated or the rewetting measure is and/or can be pursued. Furthermore, as an alternative and/or in addition to influencing the current that is and/or can be generated by the fuel cell stack, the rewetting measure can adjust and/or set a gas pressure, a gas volume flow, a gas humidity, a stoichiometry, a mass flow, and/or a temperature at/in an anode and/or at/in a cathode of the fuel cell stack in such a way that the at least one too-dry region of the fuel cell stack is and/or can be rewetted.

Through the rewetting measure, a gas pressure is and/or can be increased in the anode and/or in the cathode of the fuel cell stack, a gas volume flow is and/or can be reduced, a gas humidity is and/or can be increased, a stoichiometry can is and/or can be reduced, and/or a temperature is and/or can be reduced.

Based on the moisture quality, a time window for the rewetting measure in the fuel cell stack can be determined. At least one temporal start, temporal duration, and/or temporal end can be determined for the time window. The start, duration, and/or end of the time window can be determined from the moisture quality of the fuel cell stack.

Furthermore, the urgency of the rewetting measure can be considered. In the event of high urgency, the rewetting measure can be initiated or further processed substantially immediately. In the event of moderate urgency, the rewetting measure can be initiated or further processed when a suitable opportunity arises. And in the event of low urgency, the rewetting measure can be initiated or further processed during a shutdown procedure or in an idling state of the fuel cell assembly.

Initiation of the rewetting measure can include phasing out another measure, another process, etc. in the fuel cell assembly and/or in the fuel cell stack (blending, crossfade). Of course, the initiation of the rewetting measure can also take place only when the other measure is substantially fully phased out or completed.

The rewetting of the fuel cell stack can be carried out in a monitored fashion. In this case, if currently unfavorable conditions for rewetting exist, the rewetting process can be aborted, interrupted, or continued with modified parameters. That is to say, the method for carrying out a rewetting measure can be interrupted several times and temporarily processed until completion.

Furthermore, the moisture quality cab be determined during a shutdown, during an idling phase, and/or when starting the fuel cell assembly. The method is and/or can be carried out by a control unit for the fuel cell stack. In this case, the control unit can be configured as a control unit for the fuel cell assembly or a control unit of the fuel cell assembly. The method is or can be carried out online by an external control routine (wireless (computer) network). And the method is or can be carried out during operation, shutdown, and/or an idling phase of the fuel cell assembly.

### BRIEF DESCRIPTION OF THE DRAWINGS

The invention is explained in further detail hereinafter by way of the attached schematic drawings, which are not to scale, with reference to exemplary embodiments. In the invention, a feature can be positive, i.e., present, or negative, i.e., absent. In the present specification, a negative feature is not explicitly explained as a feature unless it is described as being absent according to the invention. In other words, what is actually achieved- and not an invention construed via the prior art-consists of omitting this feature. The absence of a feature (negative feature) in an exemplary embodiment demonstrates that the feature can be optional (at the discretion of a person skilled in the art). The figures (Fig.) in the drawing, which are merely examples, show:

FIG. 1 a simplified block diagram of an embodiment of a fuel cell assembly for a fuel cell system of a fuel cell vehicle,

FIG. 2 shows a possible flowchart of a method according to the invention for carrying out a rewetting measure of a fuel cell stack, and

FIG. 3 is an exemplary line diagram for determining a moisture quality of the fuel cell stack and carrying out the rewetting measure.

### DETAILED DESCRIPTION

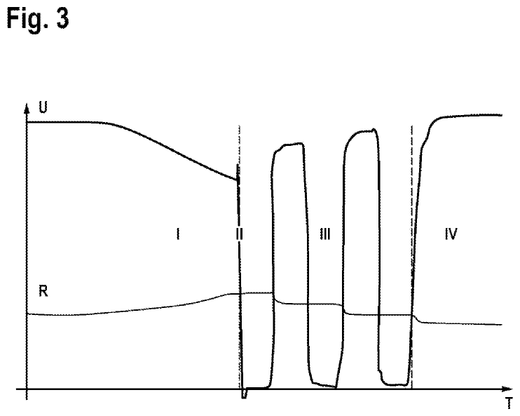

The invention is explained in further detail by means of a method 200—see FIG. 2—for carrying out an arbitrary or necessary rewetting measure of a fuel cell stack 10 of a fuel cell assembly 1, in particular for a low-temperature polymer electrolyte fuel cell system of a fuel cell vehicle, i.e., a motor vehicle comprising a fuel cell or a fuel cell system. Only those portions of the fuel cell system that are necessary for an understanding of the invention are shown in the drawings.

Although the invention is described and illustrated in further detail by way of preferred embodiments, the invention is not limited by the exemplary embodiments disclosed.

Other variations can be derived therefrom without departing from the protective scope of the invention. In particular, the invention can also be based on a different mobile or stationary fuel cell assembly 1 or fuel cell system.

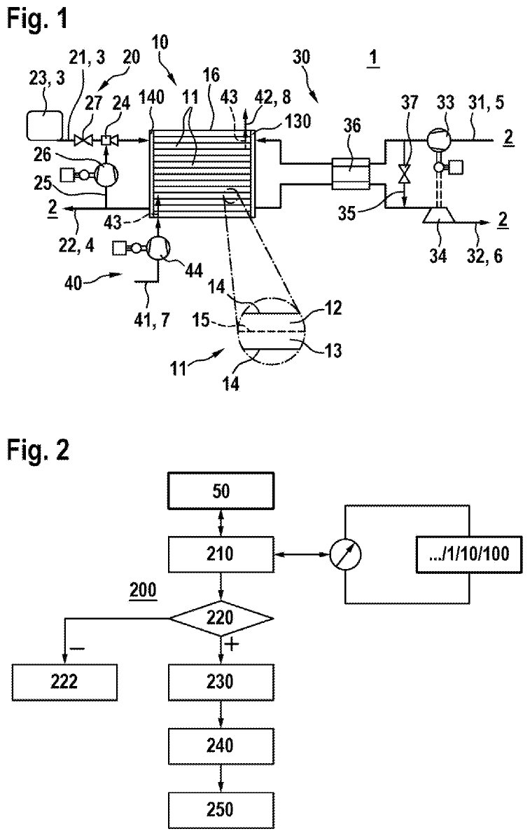

FIG. 1 shows the fuel cell unit 1 according to one embodiment, comprising at least one, in particular a plurality, of single electrochemical fuel cells 11 (single cells 11) bundled together to form a fuel cell stack 10, which are housed in a preferably fluid-tight stack housing 16. Each single cell 11 comprises an electrode chamber 12 designed as an anode chamber 12 and an electrode chamber 13 designed as a cathode chamber 13, which are spatially and electrically separated from each other by a membrane-electrode assembly 15.

Arranged in each case between two directly adjacent membrane-electrode assemblies 15, 15 (including a respective anode chamber 12 and a cathode chamber 13) is a bipolar plate 14, which is used, among other things, to feed/discharge operating media 3, 5 into an anode chamber 12 of a first single cell 11 and a cathode chamber 13 of a second single cell 11 directly adjacent thereto and, in addition, to achieve an electrically conductive connection between these single cells 11, 11. The cathode chambers 13 and possibly their common inflow region or their electrodes form a cathode 130 and the anode chambers 12 and possibly their common inflow region or their electrodes form an anode 140 of the fuel cell stack 10.

The fuel cell assembly 1 comprises an anode supply 20 and a cathode supply 30 for supplying the fuel cell stack 10 with its actual operating media 3 (anode operating medium, actual fuel), 5 (cathode operating medium, usually air).

The anode supply 20 comprises in particular: a fuel reservoir 23 for the anode operating media 3 (flowing in); an anode supply path 21 having a pressure reducer, a shut-off valve, and/or a metering valve 27 (for example) and a jet pump 24 (ejector 24); an anode exhaust path 22 for an anode exhaust gas medium 4 (flowing out, usually into the surroundings 2); preferably a fuel recirculation path 25 with a fluid conveying device 26 located therein, and optionally a water separator and optionally a water container.

The cathode supply 30 comprises in particular: a cathode supply path 31 for the cathode operating medium 5 (flowing in, usually from the surroundings 2), preferably with a fluid conveying device 33; a cathode gas path 32 for a cathode exhaust gas medium 6 (flowing out, usually into the surroundings 2) preferably with a turbine 34, in particular for the fluid conveying device 33; preferably a moisture transfer device 36, in particular a gas-to-gas moistener 36; possibly a cathode-side stack bypass 35 (waste gate 35) between the cathode supply path 31 and the cathode exhaust gas path 22, with a bypass valve 37; and optionally a water separator and optionally a water container.

The fuel cell unit 1 also comprises, in particular, a coolant supply 40 of a thermal system, in particular of the fuel cell vehicle, through which the fuel cell stack 10 can be integrated into a cooling circuit for temperature adjustment in a heat-transferring manner, preferably by means of its bipolar plates 14 (coolant paths 43). The coolant supply 40 comprises a coolant inlet path 41 and a coolant outlet path 42. The coolant 7 (flowing in), 8 (flowing out) circulating in the coolant supply 40 is preferably conveyed by means of at least one coolant conveying device 44.

In addition to the fuel cell assembly 1, the fuel cell system comprises peripheral system components, e.g., a control unit 50 (see FIG. 2), which can be one belonging to the fuel cell vehicle itself.

In the method 200 presented here by way of example—FIG. 2—a control unit 50 carries out a measurement 210 (for alternatives, see above) of at least one operating parameter of the fuel cell stack 10, the fuel cell assembly 1, or the fuel cell system. Such an operating parameter is in particular an electric high-frequency resistance R (see FIG. 3), a cell voltage U (see FIG. 3), and/or at least one other operating parameter (see above).

Using this at least one operating parameter or a combination of operating parameters of the fuel cell stack 10, the fuel cell assembly 1, and/or the fuel cell system, a moisture quality of the fuel cell stack 10 is determined. Using the moisture quality, it can be decided to what extent a rewetting measure of the fuel cell stack 10 is and/or should be carried out (see above).

The high-frequency resistance can be determined on at least one section 100 (see above) of the fuel cell stack 10. Of course, the high-frequency resistance can also be determined otherwise (see above). The cell voltage U can be determined in a similar manner. The other operating parameter can be determined on the cathode side, fuel cell stack side, and/or anode side. Furthermore, the other operating parameter can be determined on the fuel cell assembly side, e.g., in/via the coolant supply 40 of the thermal system, and/or on the fuel cell system side.

From the high-frequency resistance R, the cell voltage U, and/or at least one other operating parameter, the moisture quality of the fuel cell stack 10 is determined. The moisture quality is configured such that it represents a need for an (arbitrary to foreseeably necessary up to substantially immediately necessary) rewetting measure of the fuel cell stack 10 or a portion 100 thereof. In this case, the moisture quality can be configured so as to determine a time window (see above) for the rewetting measure in the fuel cell stack 10.

Based on the moisture quality, in a step 220 following step 210, it is determined whether or to what extent a rewetting measure in the fuel cell stack 10 is necessary. If the method 200 concludes (no: −) in step 220 that no rewetting measure is necessary (step 222), then the method 200 is ended. In such a case, the moisture quality represents a correspondingly high quality of the fuel cell stack 10; thus, no rewetting measure is necessary in the short, medium, and/or long term.

If the method 200 concludes in step 220 that a rewetting measure is necessary (yes: +), a time window (start, duration and/or end, see above) is determined for the rewetting measure in fuel cell stack 10. Within the time window, an actual rewetting measure of the fuel cell stack 10 is carried out with the steps 230, 240, 250. That is to say, starting in step 230, carrying out and, if applicable, monitoring in step 240, and ending in step 250 of the actual rewetting measure (see above).

As part of monitoring 240 of the rewetting measure, the carrying out 240 of the rewetting measure can be interrupted. This may be required, for example, due to a current power requirement, a monitoring of the fuel cell stack 10, etc. If better conditions for a rewetting measure are provided in a temporally adjacent manner, this can be resumed.

In particular, it is possible to begin and/or end the rewetting measure when shutting down the fuel cell assembly 1 and to turn off the fuel cell assembly 1 only after the rewetting measure has ended. Of course, the rewetting measure can also be carried out or brought to an end even when the fuel cell assembly 1 is idling. For this purpose, the fuel cell assembly 1 is ‘awakened’ during an idling state.

In particular, in the case of a time-controlled start of the fuel cell assembly 1, it is possible to perform the rewetting measure before a start of the fuel cell assembly 1 and to complete it when possible. This has the advantage that normal operation of the fuel cell assembly 1 with a freshly rewet fuel cell stack 10 can occur soon thereafter. Furthermore, no other preparation measures for a start of the fuel cell assembly 1 will then be necessary. The fuel cell stack 10 is already partially or substantially operational.

After the ending 330 of the rewetting measure, the fuel cell stack 10 can return to an operating state that it had before the rewetting measure, e.g., to an idling phase. Alternatively, the fuel cell stack 10 can of course assume an operating state characterized by the current requirements for the fuel cell assembly 1 or the fuel cell system, which of course can also be understood as an idling phase.

FIG. 3 shows an exemplary procedure. —Firstly (Part I—diagnostic portion), e.g., the control unit 50 detects a decrease (derivation or the like) of the cell voltage U as well as temporally (time T) parallel to this an increase (derivation or the like) of the high-frequency resistance R, e.g., due to real drying of the fuel cell stack 10. The control unit 50 determines the moisture quality, if necessary by using at least one further operating parameter.

In the chronological sequence T (Part II—detection portion), the control unit 50, at given operating conditions, as well as due to, for example, falling below a threshold of the cell voltage U and/or, for example, a threshold of the high-frequency resistance R, detects the drying of the fuel cell stack 10 via the determined moisture quality.

Based on the determined moisture quality, a further decrease in the cell voltage U and/or a further increase in the high-frequency resistance R is counteracted by a reaction of the control unit 50, i.e., a rewetting measure of the at least one too-dry region of the fuel cell stack 10. For this purpose, at least one operating parameter of the fuel cell stack 10 and/or the fuel cell assembly 1 is adjusted (see above, Part III—rewetting portion).

In the example of FIG. 3, this is done by actively influencing an electric current generated by the fuel cell stack 10 (see above). For this purpose, in the rewetting portion III, the current is first switched off (power-off phase) and subsequently switched on again (power-on phase). This can be done multiple times in a row. In FIG. 3, it is easy to see how the high-frequency resistance R drops and the cell voltage U increases due to the rewetting section III. —Instead of a current-off phase, a reduced current-on phase is also applicable (see above).

If the cell voltage U and/or the high-frequency resistance R have ‘normalized’ again in the time sequence T (Part IV—normal range), the fuel cell stack 10 or the fuel cell assembly 1 can be operated again in a normal operating mode or a now necessary operating mode, e.g., in order to prevent partial flooding of the fuel cell stack 10.

1. A method (200) for carrying out a rewetting measure of a fuel cell stack (10) of a fuel cell assembly (1), wherein,
during operation of the fuel cell assembly (1), a moisture quality of the fuel cell stack (10) is determined, which represents a degree of dryness of at least one region of the fuel cell stack (10), and, based on this moisture quality, a decision is made regarding the extent to which the rewetting measure of the at least one too-dry region of the fuel cell stack (10) should be carried out and/or is carried out, wherein the rewetting measure is carried out by actively influencing an electric current that is and/or can be generated by the fuel cell stack (10).

2. The method (200) according to claim 1, wherein, during a duration (T(III)) of the rewetting measure, the current that is and/or can be generated by the fuel cell stack (10):
is and/or can be significantly reduced,
is and/or can be intermittently generated, and/or
has a global minimum compared to a duration immediately before and/or immediately after the rewetting measure.

3. The method (200) according to claim 2, wherein, under substantially comparable specified operating conditions,
an average electrical charge generated by the fuel cell stack (10) during a/the duration (T(III)) of the rewetting measure in a unit of time is less
than an average electrical charge generated by the fuel cell stack (10) in the same unit of time during a comparison period before, after, or while determining the rewetting measure via the moisture quality.

4. The method (200) according to claim 1, wherein the current that is and/or can be generated by the fuel cell stack (10) during a/the duration (T(III)) of the rewetting measure:
is and/or can be separated into at least a current-on phase and a reduced current-on phase, in which the current that is and/or can be generated is less than in the current-on phase, or
is and/or can be separated into at least a current-on phase and a current-off phase, in which the current that is and/or can be generated is switched off compared to the current-on phase.

5. The method (200) according to claim 1, wherein
a current-on phase lasts approximately: 5 s, 15 s, 30 s, 40 s, 50 s, 60 s, 70 s, 80 s, 90 s, 105 s, 120 s, 130 s, 140 s, 150 s, 180 s, or longer,
a reduced current-on phase or a current-off phase lasts approximately: 5 s, 15 s, 30 s, 40 s, 50 s, 60 s, 70 s, 80 s, 90 s, 105 s, 120 s, 130 s, 140 s, 150 s, 180 s, or longer, and/or
a number of the reduced current-on phases or the current-off phases is approximately five, seven, ten, 15, 20, 25, 30, or more.

6. The method (200) according to claim 1, wherein the fuel cell stack (10), in at least one, a plurality, a majority, or substantially all of its
current-on phases, provides approximately: 70%, 75%, 80%, 85%, 90%, 92.5%, 95%, 97.5%, 98%, 99%, or 100% of its prevailing maximum output,
in at least one reduced current-on phase, provides approximately: 0%, 5%, 10%, 15%, 20%, 25%, 30%, 35%, 40%, 45%, 50%, 55%, or 60% of its prevailing maximum output,
current-off phase, provides approximately: 0%, 0.5%, 1%, 2%, 3%, 4%, or 5% of its prevailing maximum output.

7. The method (200) according to claim 1, wherein a shutdown or deactivation of the fuel cell stack (10) occurs during an activated current flow of the fuel cell stack (10), wherein an air volume flow into the cathode (130) of the fuel cell stack (10) is switched off.

8. The method (200) according to claim 1, wherein the moisture quality is determined:
from an electric high-frequency resistance (R) of at least one section (100) of the fuel cell stack (10),
by monitoring at least one operating parameter of the fuel cell stack (10) or the fuel cell assembly (1), and/or
by comparing at least one cell voltage (U) of the fuel cell stack (10) with a stored cell voltage (U).

9. The method (200) according to claim 1, wherein, in order to determine the high-frequency resistance (R), a high-frequency signal is superimposed on a DC signal of the fuel cell stack (10), and the determined high-frequency resistance (R) is preferably evaluated by a generating source and/or by another device.

10. The method (200) according to claim 1, wherein, in the moisture quality, a rewetting measure is represented by an increase in a high-frequency resistance (R) and a decreasing cell voltage (U) during operation of the fuel cell assembly (1), wherein
preferably, a too-dry region of the fuel cell stack (10) is represented in the moisture quality by falling below a threshold of a cell voltage (U) and/or exceeding a threshold of a high-frequency resistance (R) under given operating conditions of the fuel cell assembly (1).

11. The method (200) according to claim 1, wherein, upon detection of a too-dry region of the fuel cell stack (10) via the moisture quality,
the rewetting measure for the fuel cell stack (10) is and/or can be initiated or is and/or can be pursued.

12. The method (200) according to claim 1, wherein, based on the moisture quality:
a time window for the rewetting measure in the fuel cell stack (10) is determined,
at least one temporal start, temporal duration, and/or temporal end is determined for the time window, and/or
the start, duration, and/or end of the time window is determined from the moisture quality of the fuel cell stack (10).

13. The method (200) according to claim 1, wherein an urgency of the rewetting measure is taken into account, wherein the rewetting measure is initiated or further processed:
substantially immediately in the event of high urgency,
at a suitable opportunity that arises in the event of moderate urgency, and/or
during a shutdown procedure or in an idling state of the fuel cell assembly (1) in the event of low urgency.

14. The method (300) according to claim 13, wherein the execution of the rewetting of the fuel cell stack (10) is monitored, wherein
in the event of currently unfavorable conditions for rewetting, the execution of the rewetting is discontinued, interrupted, or further carried out with changed parameters.

15. A fuel cell assembly (1), a fuel cell system, or a fuel cell vehicle, wherein,
due to the fuel cell assembly (1), the fuel cell system, or the fuel cell vehicle, a method (200) according to claim 1 is and/or can be carried out.
